(19) United States
(12) Patent Application Publication
(10) Pub. No.: US 2012/0067584 A1
(43) Pub. Date: Mar. 22, 2012

(54) HYDROCARBON-BASED FLUID COMPOSITIONS AND METHODS OF USING SAME

(76) Inventors: Kewei Zhang, Calgary (CA); Chris Wiggins, Calgary (CA)

(21) Appl. No.: 13/050,661

(22) Filed: Mar. 17, 2011

Related U.S. Application Data
(60) Provisional application No. 61/314,860, filed on Mar. 17, 2010.

(51) Int. Cl. C09K 8/64; E21B 43/26

(52) U.S. Cl. 166/308.1; 507/203; 507/238; 507/265; 507/202; 507/261

(57) ABSTRACT

The present invention provides hydrocarbon-based fracturing fluid compositions comprising a hydrocarbon fluid, proppant, and a small amount of water, and methods of using same. The small amount of water, preferably present at a concentration ranging from about 0.1% to about 5%, causes water bridging between the proppant particulates, causing the proppant particles to agglomerate. The compositions are useful in mitigating proppant flowback in hydraulic fracturing operations and are useful in isolating one or more zones in vertical as well as horizontal wells having multiple pay zones.

### CROSS-REFERENCE TO RELATED APPLICATIONS

This application claims priority from U.S. Provisional Application Ser. No. 61/314,860, filed Mar. 17, 2010, the contents of which are hereby expressly incorporated herein by reference in its entirety.

### FIELD OF THE INVENTION

This invention relates to hydrocarbon-based fluid compositions and their use in oil field applications. In particular, this invention relates to controlling proppant flowback in oil field applications, and more particularly, controlling proppant flowback after a hydraulic fracturing treatment of subterranean formations.

### BACKGROUND OF THE INVENTION

Fluids are widely used in many industries, especially in the petroleum industry where different fluids are used in different operations including drilling, completion, wellbore cleaning, stimulation, and pipeline cleaning operations. There are two general classes of fluids: water-based fluids (i.e., aqueous fluids) and non-aqueous fluids. Alcohol-based fluids and hydrocarbon-based fluids are generally classified as non-aqueous fluids.

In general, when fluids are used in subterranean operations, the nature of the subterranean formation to a large extent dictates which types of fluids are suitable for use in such operations. Due to their low cost and high versatility, water-based fluids are normally preferred. However, certain subterranean formations are susceptible to water. When exposed to water, hydrocarbon production may decrease in such formations because of clay swelling and migration. For such water-sensitive formations, hydrocarbon-based fluids are generally preferred.

Hydraulic fracturing operations are used extensively in the petroleum industry to enhance oil and gas production. In a hydraulic fracturing operation, a fracturing fluid is injected through a wellbore into a subterranean formation at a pressure sufficient to initiate fractures to increase petroleum production.

Frequently, particulates, called proppants, are suspended in the fracturing fluid and transported as a slurry into the fractures. Proppants include sand, ceramic particles, glass spheres, bauxite (aluminum oxide), and the like and range in size from 10 to 100 U.S. mesh and most commonly from 20 to 70 mesh. Among them, sand is by far the most commonly used proppant. At the last stage of the fracturing treatment, fracturing fluid is flowed back to surface and proppants are left in the fractures to prevent the fractures from closing back after pressure is released. The proppant-filled fractures provide highly conductive channels that allow oil and/or gas to seep through to the wellbore more efficiently. The conductivity of the proppant packs formed after proppant has settled in the fractures plays a dominant role in increasing oil and gas production.

Fracturing fluids in common use include various water-based and hydrocarbon-based fluids. Perhaps the most commonly used fracturing fluids are aqueous fluids containing cross-linked polymers or linear polymers to effectively transport proppants into the fractures. Although hydrocarbon-based fluids are less popular due to their cost, they are still used significantly in certain areas. For example, in water-sensitive formations, hydrocarbon-based fracturing fluids are generally preferred. To improve their solid-carrying capability, hydrocarbon fluids are often gelled by adding gelling agents. There are two main types of hydrocarbon gelling agents: alkyl phosphate esters crosslinked by aluminum or iron compounds, and aluminum fatty acid soaps including aluminum octoate and aluminum stearate.

Currently alkyl phosphate esters crosslinked by aluminum or iron compounds are more commonly used in fracturing operations using hydrocarbon-based fracturing fluids. For example, to prepare such a fluid, a phosphate ester and an aluminum or iron compound are mixed into a hydrocarbon base liquid. The in situ reaction between the phosphate ester and the aluminum or iron compound forms aluminum or iron phosphate esters which further form three-dimensional networks gelling the hydrocarbon fluid. This method is well known in the art and examples can be found in U.S. Pat. Nos. 3,505,374; 3,990,978; 4,003,393; 4,316,810; 5,110,485; 5,693,837; 6,297,210; and Canadian Patent No. 2,552,657.

In hydraulic fracturing operations it is not unusual for a large amount of proppant to be carried out of the fracture by the fracturing fluids upon flowing back. This process is known as proppant flowback. Proppant flowback is highly undesirable as it not only reduces the amount of proppants remaining in the fractures resulting in less conductive channels, but also causes significant operational difficulties. The problem of proppant flowback has long plagued the petroleum industry because of its adverse effect on well productivity and equipment.

Numerous methods have been attempted to mitigate the damage caused by proppant flowback. Currently a common method is to use “resin-coated proppants,” where the outer surfaces of the proppants have an adherent resin coating so that the proppant grains become bonded to each other under suitable conditions forming a more stable permeable barrier to reduce proppant flowback.

Different binding agents have been used as a resin coating for proppants. For example, U.S. Pat. Nos. 3,492,147 and 3,935,339 disclose compositions and methods of coating solid particulates with different resins. The particulates to be coated include sand, nut shells, glass beads, and aluminum pellets. The resins used include urea-aldehyde resins, phenol-aldehyde resins, epoxy resins, furfuryl alcohol resins, and polyester or alkyl resins. The resins can be in pure form or mixtures containing curing agents, coupling agents or other additives. Other examples of resins and for resin mixtures for proppants are described in U.S. Pat. Nos. 5,643,669; 5,916,933; 6,059,034; and 6,328,105.

Unfortunately, there are significant limitations to the use of resin-coated proppants. For example, resin-coated proppants are much more expensive than uncoated sands, especially considering that typical fracturing treatments usually employ tons of proppants in a single well. Normally, when the formation temperature is below 60° C., activators are required to make the resin-coated proppants bind together. This further increases the cost.

Thus, the use of resin-coated proppants is limited by their high cost to only certain types of wells, or to use in only the final stages of the fracturing treatment, also known as the “tail-in,” where the last few tons of proppants are pumped into the fracture. For less economically viable wells, application of resin-coated proppants often becomes cost prohibitive.

Many wells are drilled in reservoirs that have multiple pay zones (i.e., multiple hydrocarbon bearing zones). To stimulate each zone effectively, it is crucial that the stimulation fluid, for example a fracturing fluid, be diverted to the targeted zone. It is common to use mechanical isolation to help ensure effective stimulation of each zone or groups of closely spaced zones. Other types of isolation methods involve the use of sand plugs to isolate the treated zones, which involves fracturing a lower zone, then setting a sand plug across the lower zone to isolate the treated zone, and perforating and fracturing at an upper zone. The process can be repeated for other intervals. Setting the sand plug is achieved by pumping sand slurry into the well and allowing sands to settle to the bottom. The permeability of the sand plug should be low enough to prevent the treated zones being re-fractured.

The sand plug method is simple, relatively fast and economic. Unfortunately, this method is generally incapable of isolating zones in horizontal wells as gravity pulls sands away from upper part of the well. In recent years, drilling horizontal in combination with multi-staged fracturing has become a common practice especially for tight reservoirs. Zone isolation using mechanical means is still commonly used, despite the fact that it is time consuming and expensive.

Thus, it is highly desirable to have a composition and a method that can mitigate proppant flowback after hydraulic fracturing with a hydrocarbon-based fracturing fluid. It is also highly desirable to have a composition and a method that can isolate one or more zones in vertical as well as horizontal wells having multiple pay zones.

### SUMMARY OF THE INVENTION

According to a first aspect, the invention provides a hydrocarbon-based fracturing fluid composition comprising a hydrocarbon fluid, proppant, and a small amount of water. The small amount of water, preferably present at a concentration ranging from about 0.1 to about 5%, and most preferably ranging from about 0.5% to about 5%, causes water bridging between the proppant particulates, causing the proppant to agglomerate. The hydrocarbon-based fracturing fluids of the present invention are useful in mitigating proppant flowback in hydraulic fracturing operations and are useful in isolating one or more zones in vertical as well as horizontal wells having multiple pay zones.

According to another aspect, the invention provides a use of the hydrocarbon-based fracturing fluid compositions of the present invention in hydraulic fracturing operations, particularly hydraulic fracturing operations involving subterranean formations where hydrocarbon-based fluid is preferred. In particular, the use of such fracturing fluid compositions to mitigate proppant flowback and/or to isolate one or more zones in vertical as well as horizontal wells having multiple pay zones.

This invention further provides a method of hydraulic fracturing with a hydrocarbon-based fluid composition comprising the steps of (a) mixing proppants with a small amount of water, (b) adding the proppant with water mixture from step (a) to a hydrocarbon-based fluid, and (c) injecting the fluid from step (b) into a subterranean formation at a pressure sufficient to initiate fracturing.

According to a further aspect, the invention provides a method of hydraulic fracturing using a hydrocarbon-based fracturing fluid comprising the steps of mixing a small amount of water, proppants, and a hydrocarbon-based fluid simultaneously while injecting the fluid into a subterranean formation at a pressure sufficient to initiate fracturing.

### DESCRIPTION OF THE INVENTION

Particulate agglomeration induced by liquid bridging, referred sometimes also as capillary attraction, between particulate is known. For example, a sand castle built on beach takes advantages of water bridging between sand grains. The water acts as a “physical glue” to bind sand grains together. When the sand castle dries up and the water content drops below a certain level, the castle collapses. It is worth noting that in the sand castle, there are three phases involved, i.e., sand, water and air.

Surprisingly, we have found that, similar to the sand castle on a beach, water can also act as a “physical glue” to bind proppants, such as sand grains, together in hydrocarbon-based fluids comprising proppant, water and a hydrocarbon. In this invention by taking advantages of the finding, we developed compositions and methods for various oilfield applications, including mitigating proppant flowback and isolating zones in hydraulic fracturing operations.

It is worth noting that although adding a small amount of water into hydrocarbon-based particulate slurry is simple, it is counterintuitive, as the primary reason to use the hydrocarbon fluids in the first place is to avoid water in water-sensitive formations. Normally, in hydrocarbon-based fluid applications, measures are taken to avoid mixing water with the hydrocarbon fluids. Water bridging among sand grains in hydrocarbon is unexpected. Without being bound by any particular theory, we theorize that the small amount of water added stays mainly in gaps between particulate grains bridging particulate together and forming agglomerates, and the amount of water contacting the subterranean formation will be negligible.

Also, certain types of wetting surfactants, for example, an alcohol ethoxylate non-ionic surfactants including lauryl alcohol ethoxylates can be added to the slurry. Without being bound by theory, the addition of the wetting surfactant helps the water to wet the sand surface more readily, and therefore enhance the water bridging, i.e., grain agglomeration. Accordingly, for the purposes of the present invention, the surfactant used should therefore be one that enhances grain agglomeration. Wetting surfactants are known. The selection of a particular surfactant is well within the skill of a person of ordinary skill in the art having regard to routine testing if necessary.

By utilizing the hydraulic fracturing fluids of the present invention, the proppants become bonded together, forming agglomerates, and thus forms a more stable permeable barrier to reduce proppant flowback without requiring the use of resin-coated proppants.

There are different methods for carrying out the invention. For example, in one embodiment of the present invention, during a fracturing operation, proppants (for example, dry sand, is normally used), are first mixed with a small amount of water, for example, about 0.1 to about 5% by volume, more preferably from about 0.5 to about 5%, and then added into a hydrocarbon-based fluid. The concentration of added water mainly depends on proppant (sand) concentration. Alternatively, brine water can be added to the hydrocarbon-based fluid. Examples of hydrocarbon-based fluids suitable for use in this invention include kerosene, diesel, gasoline, frac oils including Clearfrac™ frac oil, and SynOil™ 830 frac oil.

In another embodiment, sand, a hydrocarbon-based fluid and a small amount (about 0.1 to about 1% by volume) of water, or water plus a suitable wetting surfactant (as discussed above), are mixed simultaneously during a well stimulation operation. Different hydrocarbon-based fluids, including a straight hydrocarbon fluid, with or without a friction reducing agent known in the art, can be used.

The hydrocarbon fluid can be gelled by an alkyl phosphate ester or a fatty acid soap. Among the aluminum fatty acid soaps, aluminum octoate and aluminum stearate are well known. The aluminum soaps disclosed in United States Patent Publication No. 2010/0113308 are useful for the present invention. Such aluminum soaps are made by reacting a fatty acid, such as ethyl, octyl, and decyl or stearic acid with an alkoxide such as aluminum isopropoxide and aluminum sec-butoxide. The resulting products are a mixture of aluminum mono- and di-fatty acid soaps, which can be represented by the following general formula:

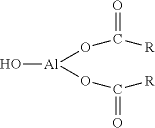

where R is a straight or branched chain alkyl group having 6 to 18 carbon atoms.

When the aluminum soap, for example aluminum octoate, is mixed into a hydrocarbon fluid including kerosene, diesel, gasoline and other aliphatic and aromatic hydrocarbons it is believed that a three-dimension network forms resulting in the formation of gel represented by the formula:

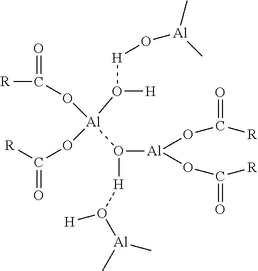

The slurry can be made on the surface or in downhole/formation in situ.

Other proppants including ceramic particulates, glass spheres, bauxite, and the like can also be used in the invention. Water or water plus a surfactant can be added for the entire sand stage of a well stimulation operation or it can be added at the last portion of the sand stage, i.e., the tail-in stage. It can be batch-mixed or mixed on-the-fly. The composition can further comprise a gas including nitrogen, carbon dioxide, methane, propane and mixtures thereof.

For sand plug applications, compositions according to the invention can be pumped into a wellbore or annular space between a wellbore and the casing, in vertical as well as in horizontal wells. Compositions according to the invention can also be used as a temporary plug during multilateral drilling. When used in zone isolation to divert fracturing fluid to targeted zones, the composition can be applied in similar manners as the gel plug, as, for example, disclosed in Canadian Patent Application 2,679,948. The method comprises injecting the composition into the wellbore and pumping a fracturing fluid into the wellbore whereby the fracturing fluid contacting the composition is diverted to a targeted zone. In another aspect, the method comprises injecting the composition into the annulus between wellbore and casing and pumping a fracturing fluid under sufficient pressure to fracture the subterranean formation.

The following provides non-limiting examples of compositions and methods according to this invention.

### EXAMPLES

Unless otherwise stated, all samples contain 25 mL by volume of proppant (natural sand, resin coated, or ceramic particles), in 100 mL of hydrocarbon-based fluid. For this testing, Clearfrac™ frac oil was used primarily as the hydrocarbon-based fluid.

### Example 1

Water was added at loadings of 5, 10, 15, 20, 30, and 50 L/m3 into the above mixture of sand and hydrocarbon-based fluid. After thoroughly mixing, a distinct cohesion of the sand was noticed at all loadings.

### Example 2

A water solution containing 10% non-ionic surfactant, an ethoxylated alcohol which is Lutensol A9N Iconol, a lauryl alcohol ethoxylate containing 9 moles of ethoxylate (EO) groups from BASF Corporation, was added to the hydrocarbon-based fluid/sand (40/70 US mesh) mix at a concentration of 5, 10, 15, 30, and 50 L/m3. After thoroughly mixing, a distinct cohesion of the sand was noticed at all loadings. And at the loading above 20 L/m3 highly cohesive mass of sand was observed.

### Example 3

The same tests described in Example 2 were performed using ceramic and resin coated proppants (20/40 US mesh). Similar results as in Example 2 were observed.

From the above description, it is clear that the inventive concepts expressed herein are well adapted to carry out the objects and to attain the advantages mentioned herein as well as those inherent in the inventive concepts expressed herein. While presently preferred embodiments of the inventive concepts disclosed herein have been described for purposes of this disclosure, it will be understood that numerous changes may be made which will readily suggest themselves to those skilled in the art and which are accomplished within the spirit of the inventive concepts disclosed and as defined in the appended claims.

What is claimed is:

1. A hydrocarbon-based fracturing fluid composition comprising:
a hydrocarbon fluid,
proppant, and
a small amount of water,
wherein the small amount of water causes the proppants to agglomerate.

2. The hydrocarbon-based fracturing fluid composition according to claim 1, wherein the hydrocarbon fluid is selected from the group consisting of: kerosene, diesel, gasoline and frac oils.

3. The hydrocarbon-based fracturing fluid composition according to claim 1, wherein the water is present at a concentration in the range of from about 0.1% to about 5%.

4. The hydrocarbon-based fracturing fluid composition according to claim 1, wherein the water is present at a concentration in the range of from about 0.5% to about 5%.

5. The hydrocarbon-based fracturing fluid composition according to claim 1, wherein the composition further comprises a gelling agent.

6. The hydrocarbon-based fracturing fluid composition according to claim 5, wherein the gelling agent is a phosphate ester.

7. The hydrocarbon-based fracturing fluid composition according to claim 5, wherein the gelling agent is a fatty acid soap.

8. The hydrocarbon-based fracturing fluid composition according to claim 5, wherein the gelling agent is aluminum octoate.

9. The hydrocarbon-based fracturing fluid composition according to claim 1, wherein the composition further comprises a gas.

10. The hydrocarbon-based fracturing fluid composition according to claim 9, wherein the gas is selected from a group consisting of nitrogen, carbon dioxide, methane, propane and mixtures thereof.

11. The hydrocarbon-based fracturing fluid composition according to claim 1, wherein the composition further comprises a wetting surfactant.

12. The hydrocarbon-based fracturing fluid composition according to claim 11, wherein the wetting surfactant is an alcohol ethoxylate.

13. The hydrocarbon-based fracturing fluid composition according to claim 11, wherein the wetting surfactant is lauryl alcohol ethoxylate.

14. The hydrocarbon-based fracturing fluid composition according to claim 1, wherein the water is brine water.

15. The hydrocarbon-based fracturing fluid composition according to claim 1, wherein the proppant is selected from the group consisting of sand, ceramic particulates, glass spheres, and bauxite particulates.

16. A method of hydraulic fracturing with a hydrocarbon-based fluid composition comprising the steps of:
a. mixing proppant with a small amount of water;
b. adding the proppant with water mixture from step (a) to a hydrocarbon-based fluid; and
c. injecting the fluid from step (b) into a subterranean formation at a pressure sufficient to initiate fracturing.

17. The method according to claim 16, wherein the hydrocarbon fluid is selected from the group consisting of: kerosene, diesel, gasoline and frac oils.

18. The method according to claim 16, wherein the water is present at a concentration in the range of from about 0.1% to about 5%.

19. The method according to claim 16, wherein the water is present at a concentration in the range of from about 0.5% to about 5%.

20. The method according to claim 16, wherein a gelling agent is added to the hydrocarbon-based fluid.

21. The method according to claim 20, wherein the gelling agent is a phosphate ester.

22. The method according to claim 20, wherein the gelling agent is a fatty acid soap.

23. The method according to claim 20, wherein the gelling agent is aluminum octoate.

24. The method according to claim 16, wherein a wetting surfactant is added to the hydrocarbon-based fluid.

25. The method according to claim 24, wherein the wetting surfactant is an alcohol ethoxylate.

26. The method according to claim 24, wherein the wetting surfactant is lauryl alcohol ethoxylate.

27. The method according to claim 16, wherein the water is brine water.

28. The method according to claim 16, wherein the proppant is selected from the group consisting of sand, ceramic particulates, glass spheres, and bauxite particulates.

29. The method according to claim 16, wherein steps (a) and (b) occur simultaneously with step (c).

30. A method of fracturing a formation containing a wellbore, comprising the steps of:
a. first injecting a hydrocarbon-based fluid composition comprising a hydrocarbon-based fluid, proppant and small amount of water; and
b. pumping a fracturing fluid into the wellbore in such a way that the fracturing fluid contacting the hydrocarbon-based fluid composition of step (a) is diverted to a targeted zone.

31. The method according to claim 30, wherein the wellbore is horizontal.
